(19) United States
(12) Patent Application Publication
(10) Pub. No.: US 2026/0061683 A1
(43) Pub. Date: Mar. 5, 2026

(54) INJECTION MOLDING APPARATUS AND MOLD CLAMPING DEVICE

(71) Applicant: SEIKO EPSON CORPORATION, Tokyo (JP)

(72) Inventor: Tetsuya TAMURA, MATSUMOTO-SHI (JP)

(21) Appl. No.: 19/310,025

(22) Filed: Aug. 26, 2025

(30) Foreign Application Priority Data
Aug. 28, 2024 (JP) 2024-146390

(51) Int. Cl. B29C 45/66; B29C 45/76

(52) U.S. Cl. CPC B29C 45/661; B29C 45/7653; B29C 2945/76083; B29C 2945/76224; B29C 2945/76391; B29C 2945/76511; B29C 2945/76568; B29C 2945/76709; B29C 2945/76869

(57) ABSTRACT

An injection molding apparatus includes an injection unit, a mold clamping unit, and a controller. The mold clamping unit includes a toggle fixing plate, a fixed mold attachment portion, a movable mold attachment portion movable in a mold clamping direction, a motor, a ball screw configured rotated by the motor, a crosshead configured to move between the toggle fixing plate and the movable mold attachment portion due to rotation of the ball screw, and a toggle section coupled to the toggle fixing plate. The movable mold attachment portion and the crosshead are configured to move the movable mold attachment portion. A position detector is configured to detect a position of the crosshead. The controller controls the position of the crosshead based on a detection result of the position detector to make the toggle section operate to perform the mold clamping of the fixed mold and the movable mold.

The present application is based on, and claims priority from JP Application Serial Number 2024-146390, filed Aug. 28, 2024, the disclosure of which is hereby incorporated by reference herein in its entirety.

### BACKGROUND

### 1. Technical Field

The present disclosure relates to an injection molding apparatus and a mold clamping device.

### 2. Related Art

JP-A-2010-162805 discloses a toggle-type electric clamping device capable of controlling an upper limit value of mold opening force by figuring out a toggle magnification at a mold opening position corresponding to set mold clamping force.

JP-A-2010-162805 is an example of the related art.

In a mold clamping operation by a toggle-type mold clamping device, a motor that moves a crosshead may be controlled based on a set value of a torque value in some cases. In this case, even when the set value of the torque value is the same, there is a possibility that the stop position of the crosshead changes every time the mold clamping is performed due to thermal expansion of components constituting the mold clamping device or a molding die and so on. Since the mold clamping force of the toggle-type mold clamping device is determined by the stop position of the crosshead, there is a possibility that the mold clamping force varies every time the mold is clamped.

### SUMMARY

According to a first aspect of the present disclosure, an injection molding apparatus is provided. The injection molding apparatus is an injection molding apparatus configured to perform injection molding of a molded article using a molding die configured with a fixed mold and a movable mold, the apparatus including an injection unit configured to inject a material of the molded article into the molding die, a mold clamping unit to which the molding die is attached and which is configured to perform mold clamping of the molding die, and a controller configured to control the injection unit and the mold clamping unit, wherein the mold clamping unit includes a toggle fixing plate, a fixed mold attachment portion to which the fixed mold is attached, a movable mold attachment portion which is disposed between the toggle fixing plate and the fixed mold attachment portion so as to be movable forward and backward in a mold clamping direction, and to which the movable mold is attached, a motor, a ball screw attached to the toggle fixing plate and configured to rotate due to driving of the motor, a crosshead configured to move between the toggle fixing plate and the movable mold attachment portion due to rotation of the ball screw, a toggle section coupled to the toggle fixing plate, the movable mold attachment portion, and the crosshead and configured to move the movable mold attachment portion along the mold clamping direction due to a movement of the crosshead, and a position detector configured to detect a position of the crosshead, and the controller drives the motor to control the position of the crosshead based on a detection result of the position detector to thereby make the toggle section operate to perform the mold clamping of the fixed mold and the movable mold.

According to a second aspect of the present disclosure, a mold clamping device is provided. The mold clamping device includes a toggle fixing plate, a fixed mold attachment portion to which a fixed mold a position of which is fixed in a mold clamping operation is attached, a movable mold attachment portion which is disposed between the toggle fixing plate and the fixed mold attachment portion so as to be movable forward and backward in a mold clamping direction, and to which a movable mold which is moved relatively to the fixed mold in the mold clamping operation is attached, a motor, a ball screw attached to the toggle fixing plate and configured to rotate due to driving of the motor, a crosshead moving between the toggle fixing plate and the movable mold attachment portion due to rotation of the ball screw, a toggle section coupled to the toggle fixing plate, the movable mold attachment portion, and the crosshead and configured to move the movable mold attachment portion along the mold clamping direction due to a movement of the crosshead, a position detector configured to detect a position of the crosshead, and a controller configured to drive the motor to control the position of the crosshead based on a detection result of the position detector, to thereby make the toggle section operate to perform mold clamping of the fixed mold and the movable mold.

### BRIEF DESCRIPTION OF THE DRAWINGS

FIG. 1 is a diagram illustrating a schematic configuration of an injection molding apparatus.

FIG. 2 is a cross-sectional view illustrating a schematic configuration of an injection unit.

FIG. 3 is a perspective view illustrating a schematic configuration of a flat screw.

FIG. 4 is a schematic plan view of a barrel.

FIG. 5 is a diagram illustrating a schematic configuration of a mold clamping unit.

FIG. 6 is a diagram illustrating a schematic configuration of the mold clamping unit.

FIG. 7 is a diagram illustrating a schematic configuration of the mold clamping unit.

FIG. 8 is a diagram illustrating a temporal change in a torque value of a motor in a mold clamping operation and a mold opening operation.

FIG. 9 is a diagram illustrating a temporal change in the torque value of the motor when a controller drives the motor based on a set value of the torque value.

FIG. 10 is a diagram illustrating a temporal change in a torque value of a motor in a mold clamping operation and a mold opening operation in a second embodiment.

FIG. 11 is a diagram illustrating a schematic configuration of a mold clamping unit in a third embodiment.

FIG. 12 is a diagram illustrating a temporal change in a torque value of a motor in a mold clamping operation and a mold opening operation in the third embodiment.

### DESCRIPTION OF EMBODIMENTS

### A. First Embodiment

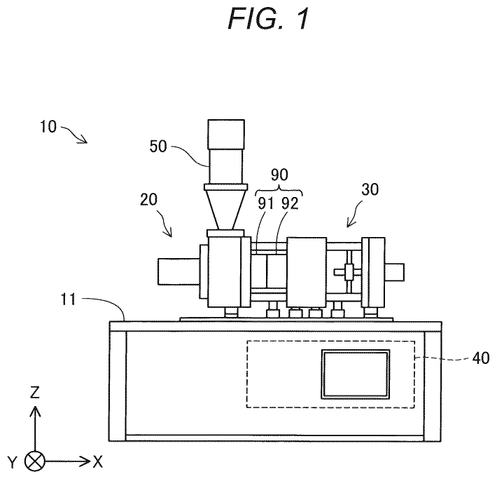

FIG. 1 is a diagram illustrating a schematic configuration of an injection molding apparatus 10. FIG. 1 shows arrows indicating X, Y, and Z directions perpendicular to one another. The X direction and the Y direction are directions parallel to a horizontal plane. The Z direction is a direction parallel to a vertical direction. The X, Y, and Z directions in FIG. 1 and the X, Y, and Z directions in other drawings indicate the same directions. When specifying an orientation, a positive or negative sign is used together with the description of the direction, defining a positive direction which is a direction pointed by an arrow as “+”, and a negative direction which is a direction opposite to the direction pointed by the arrow as “−”.

The injection molding apparatus 10 includes an injection unit 20, a mold clamping unit 30, and a controller 40. The injection molding apparatus 10 performs injection molding of a molded article using a molding die 90 attached to the mold clamping unit 30. The injection unit 20 and the mold clamping unit 30 are fixed on a base 11. The injection molding apparatus 10 is a horizontal injection molding apparatus, and the injection unit 20 and the mold clamping unit 30 are arranged in a horizontal direction. The controller 40 is housed in the base 11.

The controller 40 controls the injection unit 20 and the mold clamping unit 30. The controller 40 is configured with a computer having a single processor or a plurality of processors, a memory, and an input-output interface that inputs and outputs signals from and to the outside. The controller 40 achieves various functions such as a function of executing processing of molding a molded article by the processor executing a program or commands loaded onto a main storage device. Note that the controller 40 may be implemented by a configuration in which a plurality of circuits for realizing at least a part of each of the functions is combined with each other, instead of being configured with a computer.

The molding die 90 made of metal is attached to the mold clamping unit 30. The molding die 90 made of metal is referred to as a metal mold. The molding die 90 includes a fixed mold 91 and a movable mold 92. The fixed mold 91 is a mold the position of which is fixed in a mold clamping operation. The movable mold 92 is a mold that is moved relatively to the fixed mold 91 in the mold clamping operation. The movable mold 92 is moved in a mold clamping direction with respect to the fixed mold 91 by the mold clamping unit 30. In the present embodiment, the mold clamping direction is the −X direction. The molding die 90 is not limited to one made of metal, and may be one made of resin or ceramic.

A hopper 50 into which a material for the molded article is put is coupled to the injection unit 20. As the material for the molded article, thermoplastic resin formed in a pellet shape is used. As the thermoplastic resin, acrylonitrile butadiene styrene (ABS), polycarbonate (PC), polyacetal (POM), polypropylene (PP), polybutylene terephthalate (PBT), and the like are used. The material for the molded article may contain metal or ceramic in addition to the thermoplastic resin. The supply of the material to the injection unit 20 is not limited to the supply from the hopper 50 but may be performed, for example, via a tube through which the material is pumped.

The injection unit 20 plasticizes at least a part of the material supplied from the hopper 50 to generate a molding material, and injects the molding material thus generated into the molding die 90. In the present specification, “plasticizing” refers to a concept including melting, and means changing from a solid to a state having fluidity. Specifically, in the case of a material in which glass transition occurs, plasticizing refers to setting the temperature of the material to the glass transition point or higher. In the case of a material in which glass transition does not occur, plasticizing means setting the temperature of the material to the melting point or higher.

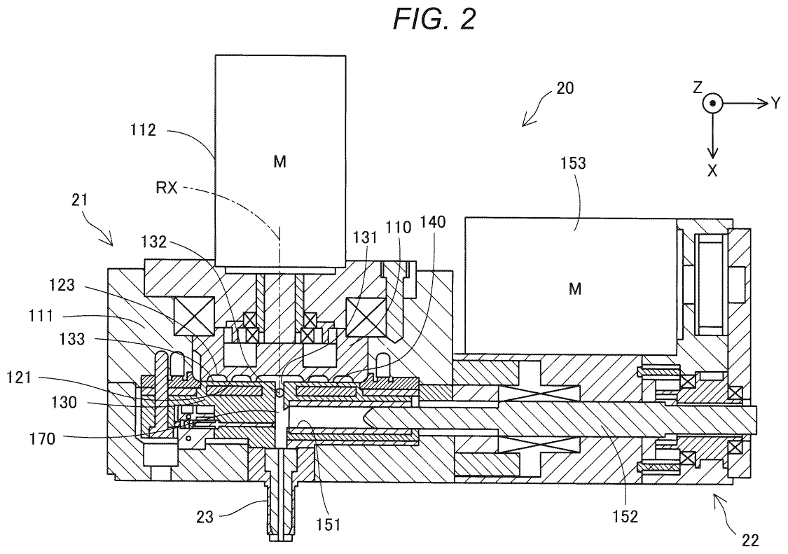

FIG. 2 is a cross-sectional view illustrating a schematic configuration of the injection unit 20. The injection unit 20 includes a plasticizing unit 21, a suction feeding unit 22, and a nozzle 23.

The plasticizing unit 21 plasticizes at least a part of the material supplied from the hopper 50 to generate the molding material. The plasticizing unit 21 includes a flat screw 110, a barrel 130, and a heater 140. The flat screw 110 is housed in a screw case 111. The flat screw 110 is also called a rotor or simply called a screw. The flat screw 110 is rotationally driven by a drive motor 112 about a rotational axis RX inside the screw case 111. In the present embodiment, a direction of the rotational axis RX is along the X direction. A communication hole 131 is formed at the center of the barrel 130. The communication hole 131 forms at least a part of a flow path 170 through which the molding material flows. An injection cylinder 151 described later is coupled to the communication hole 131. The communication hole 131 is provided with a check valve 132 upstream of the injection cylinder 151. A rotation of the flat screw 110 by the drive motor 112 and heating by the heater 140 are controlled by the controller 40.

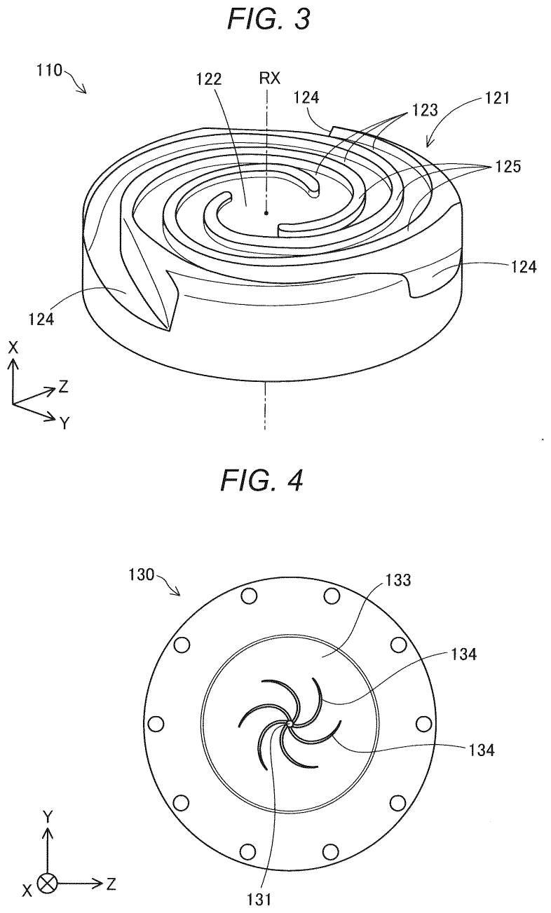

FIG. 3 is a perspective view illustrating a schematic configuration of the flat screw 110. The flat screw 110 has a substantially cylindrical shape having a height in a direction along the center axis thereof smaller than the diameter. On a groove forming surface 121 of the flat screw 110 facing the barrel 130, spiral grooves 123 are formed centering on a central portion 122. The grooves 123 communicate with a material inlet 124 provided to a side surface of the flat screw 110. A material supplied from the hopper 50 is supplied to the grooves 123 through the material inlet 124. The grooves 123 are formed by being partitioned by convex ridges 125. FIG. 3 illustrates an example in which three grooves 123 are formed, but the number of grooves 123 may be one or may be two or more. Note that the shape of the groove 123 is not limited to a spiral shape and may be a helical shape or an involute curve shape or may be a shape extending so as to draw an arc from the central portion 122 toward the outer circumference.

FIG. 4 is a schematic plan view of the barrel 130. The barrel 130 has an opposed surface 133 opposed to the groove forming surface 121 of the flat screw 110. The communication hole 131 is formed at the center of the opposed surface 133. A plurality of guide grooves 134 coupled to the communication hole 131 and extending in a spiral shape from the communication hole 131 toward the outer circumference is formed on the opposed surface 133. The material supplied to the grooves 123 of the flat screw 110 flows along the grooves 123 and the guide grooves 134 due to a rotation of the flat 110 while being plasticized between the flat screw 110 and the barrel 130 by the rotation of the flat screw 110 and heating by the heater 140, and is guided to the central portion 122 of the flat screw 110. The material flowing in the central portion 122 flows out to the suction feeding unit 22 from the communication hole 131 formed at the center of the barrel 130. Note that the guide grooves 134 are not required to be provided to the barrel 130. Further, the guide grooves 134 are not required to be coupled to the communication hole 131.

As shown in FIG. 2, the suction feeding unit 22 includes an injection cylinder 151, a plunger 152, and a plunger driver 153. The suction feeding unit 22 has a function of injecting the molding material located in the injection cylinder 151 into a cavity defined between the fixed mold 91 and the movable mold 92. The suction feeding unit 22 controls an injection amount, an injection speed, and injection pressure of the molding material injected from the nozzle 23 under the control of the controller 40. The injection cylinder 151 is a substantially cylindrical member coupled to the communication hole 131 of the barrel 130 and has the plunger 152 inside. The plunger 152 slides inside the injection cylinder 151 and pumps the molding material located in the injection cylinder 151 to the nozzle 23 provided to the injection unit 20. The plunger 152 is driven by the plunger driver 153 configured with a motor.

The flow path 170 is provided to the nozzle 23. By the plunger 152 pressure-feeding the molding material located in the injection cylinder 151 to the nozzle 23, the molding material is injected from the nozzle 23 to the molding die 90. The nozzle 23 may be configured as an open gate type nozzle or may be configured as a valve gate type nozzle.

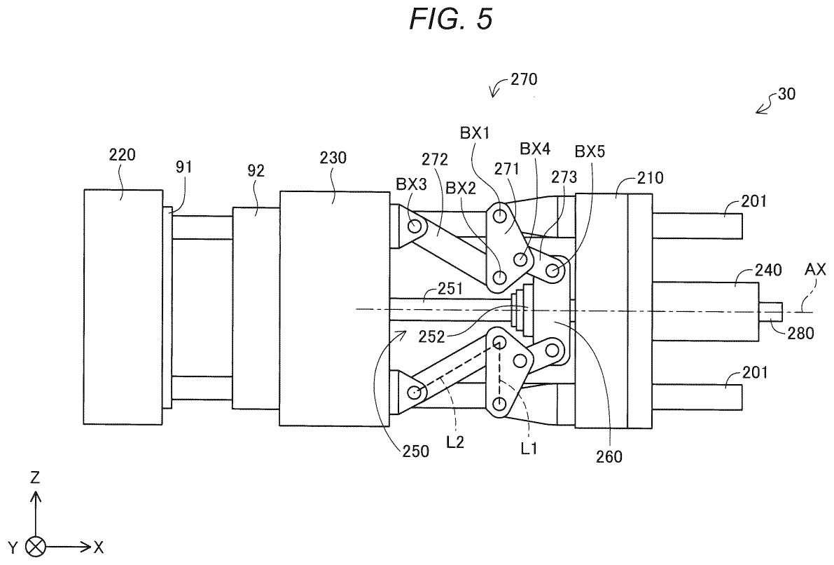

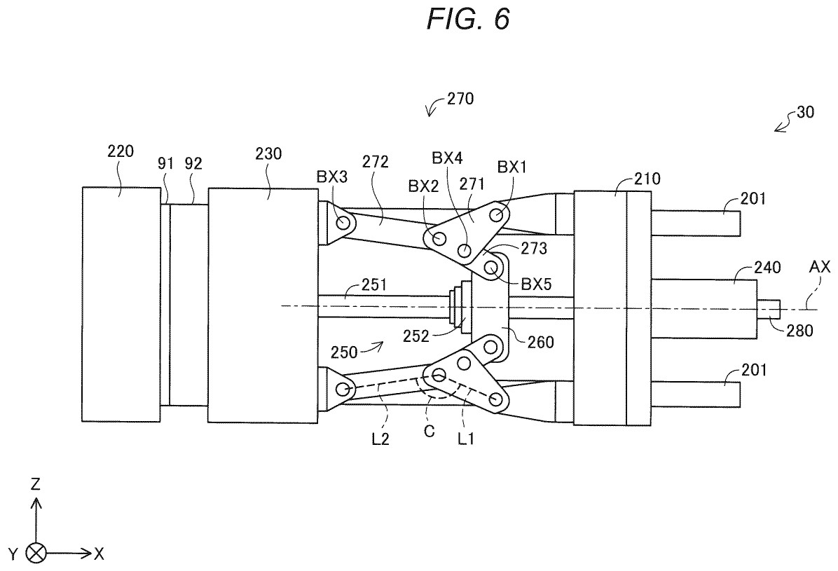

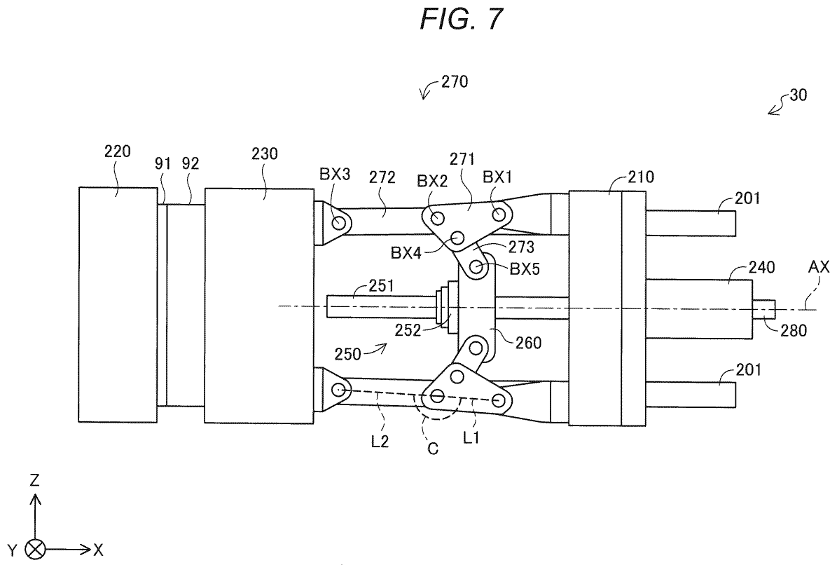

FIGS. 5 to 7 are diagrams illustrating a schematic configuration of the mold clamping unit 30. The mold clamping unit 30 performs the mold clamping of the molding die 90 attached to the mold clamping unit 30. FIG. 5 shows a state in which the molding die 90 is opened, and FIGS. 6 and 7 show a clamped state of the molding die 90. The mold clamping unit 30 includes a toggle fixing plate 210, a fixed mold attachment portion 220, a movable mold attachment portion 230, a motor 240, a ball screw 250, a crosshead 260, a toggle section 270, and a position detector 280.

The fixed mold attachment portion 220 is fixed to end portions at the −X direction side of tie bars 201 extending in the X direction. The fixed mold 91 is attached to the fixed mold attachment portion 220. The toggle fixing plate 210 is fixed to the tie bars 201 at the +X direction side of the fixed mold attachment portion 220. The movable mold attachment portion 230 is disposed between the fixed mold attachment portion 220 and the toggle fixing plate 210 so as to be movable along the extending direction of the tie bars 201. That is, the movable mold attachment portion 230 is disposed so as to be movable forward and backward in the mold clamping direction. The movable mold 92 is attached to the movable mold attachment portion 230 so as to face the fixed mold 91.

The motor 240 rotates the ball screw 250 described later. The motor 240 is, for example, a servomotor. The motor 240 is controlled by the controller 40.

The ball screw 250 is disposed between the toggle fixing plate 210 and the movable mold attachment portion 230. The ball screw 250 includes a screw shaft 251 and a ball screw nut 252. The screw shaft 251 is attached to the toggle fixing plate 210 so as to protrude in the −X direction from the toggle fixing plate 210. The screw shaft 251 is coupled to an output shaft of the motor 240 via a coupling (not shown). The screw shaft 251 rotates around an axis AX thereof by driving of the motor 240. The axis AX is along the X direction. The ball screw nut 252 moves in the X direction as the screw shaft 251 rotates.

The crosshead 260 is fixed to the ball screw nut 252. Therefore, when the ball screw nut 252 moves in the X direction with the rotation of the screw shaft 251, the crosshead 260 also moves in the X direction together with the ball screw nut 252. That is, the crosshead 260 moves in the X direction between the toggle fixing plate 210 and the movable mold attachment portion 230 due to the rotation of the ball screw 250.

The toggle section 270 is coupled to the toggle fixing plate 210, the movable mold attachment portion 230, and the crosshead 260. The toggle section 270 includes a first member 271, a second member 272, and a third member 273. The first member 271, the second member 272, and the third member 273 are disposed symmetrically about a horizontal plane including the axis AX of the screw shaft 251.

The first member 271 is coupled to the toggle fixing plate 210 via a first rotary shaft BX1. An axis of the first rotary shaft BX1 is along the Y direction. The first member 271 is disposed so as to be rotatable about the first rotary shaft BX1 in the X-Z plane. The first member 271 is also called a crank.

One end of the second member 272 is coupled to the first member 271 via a second rotary shaft BX2, and the other end thereof is coupled to the movable mold attachment portion 230 via a third rotary shaft BX3. Axes of the second rotary shaft BX2 and the third rotary shaft BX3 are along the Y direction. The second member 272 is disposed so as to be rotatable relatively to the first member 271 in the X-Z plane about the second rotary shaft BX2. In addition, the second member 272 is disposed so as to be rotatable relatively to the movable mold attachment portion 230 in the X-Z plane about the third rotary shaft BX3. The second member 272 is also called a connecting rod.

One end of the third member 273 is coupled to the first member 271 via a fourth rotary shaft BX4, and the other end thereof is coupled to the crosshead 260 via a fifth rotary shaft BX5. Axes of the fourth rotary shaft BX4 and the fifth rotary shaft BX5 are along the Y direction. The third member 273 is disposed so as to be rotatable relatively to the first member 271 in the X-Z plane about the fourth rotary shaft BX4. In addition, the third member 273 is disposed so as to be rotatable relatively to the crosshead 260 in the X-Z plane about the fifth rotary shaft BX5. The third member 273 is also called a link.

When the crosshead 260 moves in the −X direction, the members of the toggle section 270 rotate about the respective rotary shafts, so that the movable mold attachment portion 230 moves in the −X direction. Thus, the mold clamping of the molding die 90 is performed. When the crosshead 260 moves in the +X direction, the members of the toggle section 270 rotate about the respective rotary shafts, so that the movable mold attachment portion 230 moves in the +X direction. Thus, the mold opening of the molding die 90 is performed. In other words, the toggle section 270 moves the movable mold attachment portion 230 along the mold clamping direction due to the movement of the crosshead 260. Hereinafter, the rotations of the members of the toggle section 270 about the respective rotary shafts are also referred to as an operation of the toggle section 270.

The position detector 280 detects a position of the crosshead 260. The position detector 280 is, for example, an encoder provided in the motor 240. The position detector 280 indirectly detects the position of the crosshead 260 in the mold clamping direction by detecting the number of rotations and the rotation angle of the motor 240. Note that the position detector 280 may be an optical sensor or the like that directly detects the position of the crosshead 260 in the mold clamping direction instead of the encoder.

The controller 40 makes the toggle section 270 operate to thereby perform the mold clamping and the mold opening of the fixed mold 91 and the movable mold 92 by driving the motor 240 to control the position of the crosshead 260 based on the detection result of the position detector 280. In the present disclosure, controlling the position of the crosshead 260 by driving the motor 240 based on the detection result of the position detector 280 is also referred to as position control.

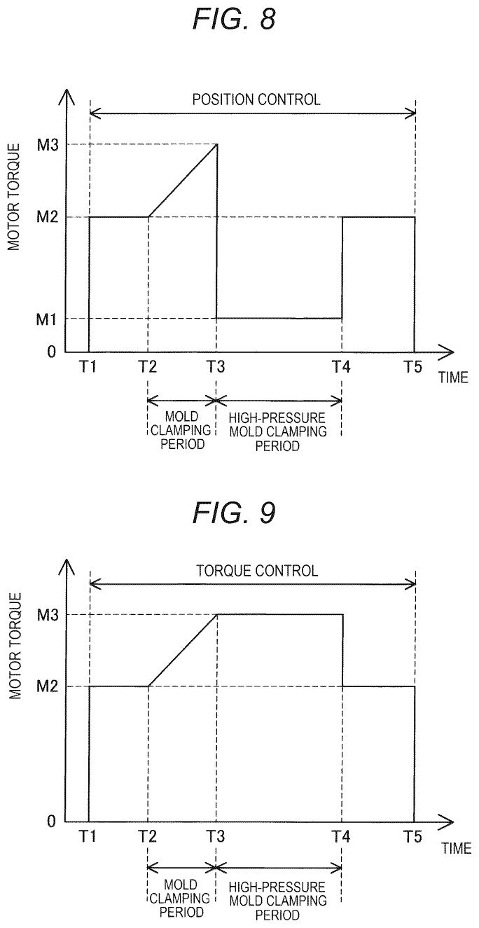

FIG. 8 is a diagram illustrating a temporal change in a torque value of the motor 240 in the mold clamping operation and the mold opening operation. In FIG. 8, the horizontal axis represents time, and the vertical axis represents a measured value of the torque value of the motor 240. The mold clamping operation and the mold opening operation will hereinafter be described with reference to FIGS. 5 to 8.

FIG. 5 shows a state of the mold clamping unit 30 at the time T1. At the time T1, the fixed mold 91 and the movable mold 92 are separated from each other. The position of the crosshead 260 at the time T1 is hereinafter referred to as a first position.

From the time T1 to the time T2, the controller 40 drives the motor 240 to move the crosshead 260 in the −X direction so that the crosshead 260 moves to a second position as a predetermined position. This moves the movable mold attachment portion 230 in the −X direction. Here, the second position is a position where the fixed mold 91 and the movable mold 92 come into contact with each other. Whether the crosshead 260 has moved to the second position is determined based on the detection result of the position detector 280. The movement of the crosshead 260 to the second position is completed at the time T2. That is, the fixed mold 91 and the movable mold 92 come into contact with each other at the time T2. FIG. 6 shows the state of the mold clamping unit 30 at the time T2. In the second position, a bending angle C that is an angle between a line L1 connecting the center of the first rotary shaft BX1 and the center of the second rotary shaft BX2 and a line L2 connecting the center of the second rotary shaft BX2 and the center of the third rotary shaft BX3 is preferably no smaller than 150° and no larger than 175°. Here, the bending angle C is an angle at a far side from the ball screw 250 in the Z direction in the angle between the line L1 and the line L2. Further, as shown in FIG. 8, the torque value of the motor 240 is constant at M2 in a period between the time T1 and the time T2.

From the time T2 to the time T3, the controller 40 drives the motor 240 to move the crosshead 260 in the −X direction so that the crosshead 260 moves to a third position as a predetermined position. The third position is a position at the −X direction side of the second position, and is a position where the bending angle C is 180°. In other words, the third position is a position at which the directions of the line L1 and the line L2 are along the same direction. Whether the crosshead 260 has moved to the third position is determined based on the detection result of the position detector 280. The movement of the crosshead 260 to the third position is completed at the time T3. FIG. 7 shows the state of the mold clamping unit 30 at the time T3. By the crosshead 260 moving from the second position to the third position in a period from the time T2 to the time T3, the mold clamping of the fixed mold 91 and the movable mold 92 is performed. Further, as shown in FIG. 8, the torque value of the motor 240 increases from M2 to M3 from the time T2 to the time T3. In the present embodiment, the torque value of the motor 240 in the period from the time T2 to the time T3 is also referred to as first torque. That is, in the period from the time T2 to the time T3, the mold clamping of the fixed mold 91 and the movable mold 92 is performed with the first torque. The first torque is a value no less than M2 and no more than M3. The period from the time T2 to the time T3 is also referred to as a mold clamping period.

From the time T3 to the time T4, the controller 40 drives the motor 240 so that the crosshead 260 maintains the third position. By the crosshead 260 keeping the third position, the mold clamping of the fixed mold 91 and the movable mold 92 is performed at pressure higher than the pressure in the clamping period. A period from the time T3 to the time T4 is also referred to as a high-pressure mold clamping period. The injection unit 20 injects the molding material into the molding die 90 during the high-pressure mold clamping period. The mold clamping period and the high-pressure mold clamping period are periods in which the mold clamping of the fixed mold 91 and the movable mold 92 is performed. As shown in FIG. 8, the torque value of the motor 240 in the period from the time T3 to the time T4 is constant at M1. The torque value M1 is a value smaller than the torque value M2 of the motor 240 in the period from the time T1 to the time T2 and the torque value M3 of the motor 240 at the time T3. Hereinafter, the torque value of the motor 240 in the period from the time T3 to the time T4 is also referred to as second torque. That is, in the period from the time T3 to the time T4, the mold clamping of the fixed mold 91 and the movable mold 92 is performed with the second torque. The second torque is a value smaller than the first torque.

From the time T4 to the time T5, the controller 40 drives the motor 240 to move the crosshead 260 in the +X direction so that the crosshead 260 moves to the first position. As a result, the movable mold attachment portion 230 moves in the +X direction. Whether the crosshead 260 has moved to the first position is determined based on the detection result of the position detector 280. The movement of the crosshead 260 to the first position is completed at the time T5. That is, the mold opening of the molding die 90 is performed from the time T4 to the time T5.

According to the first embodiment described hereinabove, the controller 40 makes the toggle section 270 operate to thereby perform the mold clamping of the fixed mold 91 and the movable mold 92 by driving the motor 240 to control the position of the crosshead 260 based on the detection result of the position detector 280 for detecting the position of the crosshead 260. Therefore, the stop position of the crosshead 260 at the time of the mold clamping can more precisely be controlled compared to when the controller 40 drives the motor 240 based on the set value of the torque value to control the position of the crosshead 260. Since the mold clamping force is determined by the stop position of the crosshead 260, it is possible to suppress the variation of the mold clamping force when the mold clamping is repeatedly performed, and thus, the accuracy of the mold clamping can be improved.

FIG. 9 is a diagram illustrating a temporal change in the torque value of the motor 240 in the mold clamping operation and the mold opening operation when the controller 40 controls the position of the crosshead 260 by driving the motor 240 based on the set value of the torque value. In the present disclosure, controlling the position of the crosshead 260 by driving the motor 240 based on the set value of the torque value is also referred to as torque control. In the example shown in FIG. 9, the set value of the torque value is constant at M2 in the period from the time T1 to the time T2, increases from M2 to M3 in the period from the time T2 to the time T3, is constant at M3 in the period from the time T3 to the time T4, and is constant at M2 from in the period from the time T4 to the time T5. The controller 40 drives the motor 240 so that the torque value of the motor 240 becomes M3 in the period from the time T3 to the time T4, which is the high-pressure mold clamping period. In this case, the crosshead 260 is held at the third position by being pressed against a member (not illustrated) provided so as not to move toward the −X direction beyond the third position by driving of the motor 240 in a state where the crosshead 260 is in contact with that member. That is, the torque value of the motor 240 in the high-pressure mold clamping period is higher than that in the first embodiment. In contrast, the injection molding apparatus 10 according to the first embodiment can reduce the torque value of the motor 240 in the high-pressure mold clamping period compared to the case described above. Therefore, the life of the motor 240 can further be extended.

Further, in the present embodiment, in the high-pressure mold clamping period, the controller 40 controls the position of the crosshead 260 such that the direction of the line L1 connecting the center of the first rotary shaft BX1 and the center of the second rotary shaft BX2 and the direction of the line L2 connecting the center of the second rotary shaft BX2 and the center of the third rotary shaft BX3 are along the same direction. Therefore, it is possible to make it easy to keep the bending angle C at 180° in the high-pressure mold clamping period. Accordingly, it is possible to make it easy for the toggle section 270 to stably receive the force applied to the toggle section 270 when the molding material is injected into the molding die 90, and thus, it is possible to further extend the life of the toggle section 270.

Further, in the present embodiment, the controller 40 controls the position of the crosshead 260 so that the mold clamping of the fixed mold 91 and the movable mold 92 is performed with the first torque and then the mold clamping is performed with the second torque lower than the first torque in the period in which the mold clamping of the fixed mold 91 and the movable mold 92 is performed. Therefore, the life of the motor 240 can further be extended.

Further, in the present embodiment, the crosshead 260 is located in the high-pressure clamping period at the −X direction side of a position where the crosshead 260 is located in the clamping period. Therefore, mold clamping pressure in the high-pressure mold clamping period is higher than the mold clamping pressure in the mold clamping period. Therefore, in the injection molding high in injection pressure, it is possible to reduce the possibility that the mold clamping between the fixed mold 91 and the movable mold 92 becomes insufficient.

### B. Second Embodiment

In a second embodiment, the control method of the motor 240 by the controller 40 is different from that of the first embodiment. Configurations of elements in the injection molding apparatus 10 in the second embodiment are the same as those in the first embodiment.

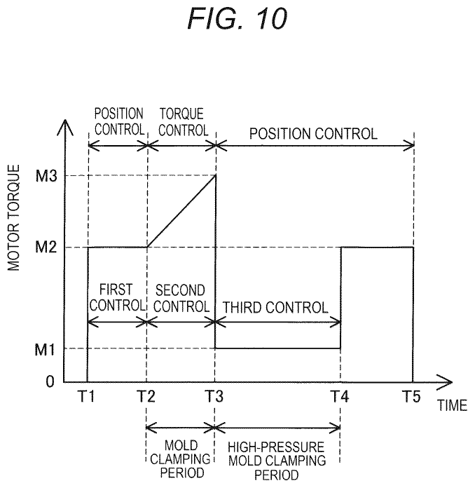

FIG. 10 is a diagram illustrating a temporal change in the torque value of the motor 240 in the mold clamping operation and the mold opening operation in the second embodiment. In the second embodiment, the controller 40 drives the motor 240 based on the set value of the torque value in the mold clamping period. The controller 40 drives the motor 240 based on the detection result of the position detector 280 similarly to the first embodiment in other periods than the mold clamping period. That is, the controller 40 performs the torque control in the mold clamping period, and performs the position control in other periods than the mold clamping period.

Similarly to the first embodiment, from the time T1 to the time T2, the controller 40 drives the motor 240 to move the crosshead 260 in the −X direction so that the crosshead 260 moves to the second position. As a result, the fixed mold 91 and the movable mold 92 come into contact with each other. In other words, the controller 40 makes the toggle section 270 operate to thereby bring the fixed mold 91 and the movable mold 92 into contact with each other by driving the motor 240 to control the position of the crosshead 260 based on the detection result of the position detector 280. In the present disclosure, the control described above is also referred to as first control. That is, the controller 40 performs the first control from the time T1 to the time T2.

From the time T2 to the time T3, the controller 40 drives the motor 240 so that the torque value of the motor 240 increases from M2 to M3. Here, M2 and M3 are set values of the torque value set in advance. In the second embodiment, the torque at the time T2 is referred to as third torque, and the torque at the time T3 is referred to as fourth torque. The value of the third torque is M2. The value of the fourth torque is M3. That is, the mold clamping of the fixed mold 91 and the movable mold 92 is performed with the third torque and then the mold clamping is performed with the fourth torque higher than the third torque. The controller 40 controls the torque value of the motor 240 so that the mold clamping of the fixed mold 91 and the movable mold 92 is performed with the third torque and then the mold clamping is performed with the fourth torque by performing control of gradually increasing the torque value from M2 to M3. In the present disclosure, the control described above is also referred to as second control. That is, the controller 40 performs the second control from the time T2 to the time T3 after performing the first control. By the controller 40 performing the second control, the crosshead 260 is moved from the second position to the third position.

Similarly to the first embodiment, from the time T3 to the time T4, the controller 40 drives the motor 240 so that the crosshead 260 keeps the third position. The torque value of the motor 240 in the period from the time T3 to the time T4 is constant at M1. M1 is a value smaller than M2 and M3. In the second embodiment, the torque in the period from the time T3 to the time T4 is also referred to as fifth torque. The value of the fifth torque is M1. In other words, the controller 40 drives the motor 240 to control the position of the crosshead 260 based on the detection result of the position detector 280 so that the mold clamping of the fixed mold 91 and the movable mold 92 is performed with the fifth torque lower than the third torque. In the present disclosure, the control described above is also referred to as third control. That is, the controller 40 performs the third control from the time T3 to the time T4 after performing the second control.

Similarly to the first embodiment, from the time T4 to the time T5, the controller 40 drives the motor 240 to move the crosshead 260 in the +X direction so that the crosshead 260 moves to the first position. Thus, the mold opening of the molding die 90 is performed.

According to the second embodiment described hereinabove, the controller 40 performs the first control as the position control, the second control as the torque control, and the third control as the position control in this order. In the second control, the controller 40 controls the torque value of the motor 240 so that the mold clamping of the fixed mold 91 and the movable mold 92 is performed with the third torque and then the mold clamping is performed with the fourth torque, and moves the crosshead 260 from the second position to the third position. Therefore, even in the mold clamping operation requiring strong mold clamping force, it is possible to make it easy to move the crosshead 260 to the third position, and therefore, the possibility that the mold clamping of the fixed mold 91 and the movable mold 92 becomes insufficient can be reduced.

### C. Third Embodiment

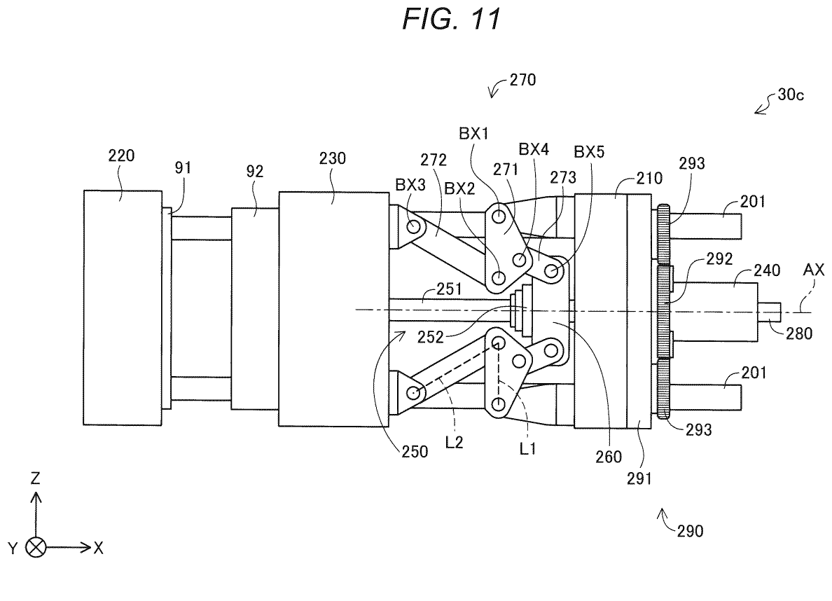

FIG. 11 is a diagram illustrating a schematic configuration of a mold clamping unit 30c in a third embodiment. In the third embodiment, the mold clamping unit 30c further includes a fixing plate moving section 290 that moves the toggle fixing plate 210 along the mold clamping direction. Configurations of elements of the injection unit 20 and the controller 40 in the third embodiment are the same as those in the first embodiment.

The fixing plate moving section 290 includes a base portion 291, a first gear 292, second gears 293, and a fixing plate moving motor (not illustrated). The base portion 291 is attached to the +X direction side of the fixing plate moving section 290. The first gear 292 and the second gears 293 are attached to the +X direction side of the base portion 291 such that axes thereof are along the X direction. The first gear 292 is coupled to the fixing plate moving motor, and rotates around an axis of the first gear 292 due to driving of the fixing plate moving motor. The fixing plate moving motor is controlled by the controller 40. The second gears 293 mesh with the first gear 292. The second gear 293 has a through hole penetrating the second gear 293 in the X direction. A screw thread is formed on an inner surface of the through hole. The tie bar 201 is located in the through hole. The screw thread on the inner surface of the through hole is screwed into a screw groove formed on a surface of the tie bar 201. Therefore, when the first gear 292 rotates about the axis of the first gear 292, the second gears 293 rotate about the respective axes, and the fixing plate moving section 290 moves in the X direction along the tie bars 201. As a result, the toggle fixing plate 210 moves along the mold clamping direction.

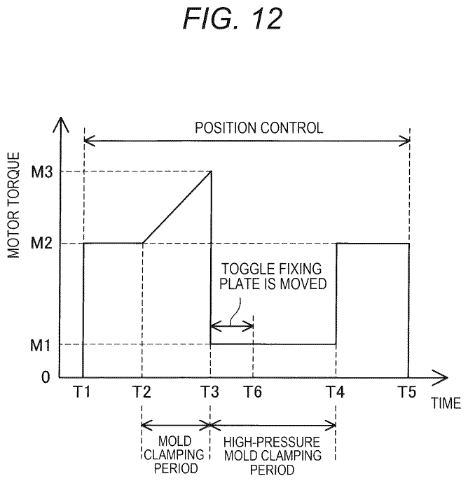

FIG. 12 is a diagram illustrating a temporal change in the torque value of the motor 240 in the mold clamping operation and the mold opening operation in the third embodiment. The controller 40 performs the position control similarly to the first embodiment. The controller 40 further controls the fixing plate moving section 290 to move the toggle fixing plate 210 toward a direction in which the mold clamping pressure increases during the period in which the mold clamping of the fixed mold 91 and the movable mold 92 is performed. The direction in which the mold clamping pressure increases is the −X direction, which is the mold clamping direction. The controller 40 controls the fixing plate moving section 290 to move the toggle fixing plate 210 in the −X direction from the time T3 to the time T6, which is a time between the time T3 and the time T4. That is, the controller 40 controls the fixing plate moving section 290 to move the toggle fixing plate 210 in the −X direction during the high-pressure mold clamping period. Thus, in the third embodiment, the mold clamping force in the high-pressure mold clamping period is stronger than that in the first embodiment. Note that the time at which the controller 40 controls the fixing plate moving section 290 to move the toggle fixing plate 210 in the −X direction is not limited to the time in a period from the time T3 to the time T6, and may be another time in the high-pressure mold clamping period.

According to the third embodiment described hereinabove, the mold clamping unit 30c includes the fixing plate moving section 290 that moves the toggle fixing plate 210 along the mold clamping direction, and the controller 40 controls the fixing plate moving section 290 to move the toggle fixing plate 210 toward the direction in which the mold clamping pressure increases during the period in which the mold clamping of the fixed mold 91 and the movable mold 92 is performed. Therefore, the mold clamping force of the mold clamping unit 30c can further be increased. Further, when the size or the thickness of the molding die 90 to be attached to the mold clamping unit 30c is changed, the mold clamping force can be adjusted to an appropriate value for the molding die 90 attached to the mold clamping unit 30c.

### D. Other Embodiments

(D-1) In the embodiments described above, the third position is a position where the bending angle C is 180°. In contrast, the third position is not limited to the position where the bending angle C is 180°. The third position is preferably a position where the bending angle C is no less than 178° and no more than 180°. That is, at the third position, the line L1 and the line L2 are not required to completely be parallel to each other.

(D-2) In the embodiments described above, the controller 40 controls the position of the crosshead 260 such that the direction of the line L1 connecting the center of the first rotary shaft BX1 and the center of the second rotary shaft BX2 and the direction of the line L2 connecting the center of the second rotary shaft BX2 and the center of the third rotary shaft BX3 are along the same direction in the period in which the mold clamping of the fixed mold 91 and the movable mold 92 is performed. In contrast, the controller 40 is not required to control the position of the crosshead 260 such that the directions of the line L1 and the line L2 are along the same direction in the period in which the mold clamping of the fixed mold 91 and the movable mold 92 is performed.

(D-3) In the embodiments described above, the controller 40 controls the position of the crosshead 260 so that the mold clamping of the fixed mold 91 and the movable mold 92 is performed with the first torque and then the mold clamping is performed with the second torque lower than the first torque in the period in which the mold clamping of the fixed mold 91 and the movable mold 92 is performed. In contrast, the controller 40 is not required to control the position of the crosshead 260 so that the mold clamping of the fixed mold 91 and the movable mold 92 is performed with the first torque and then the mold clamping is performed with the second torque in the period in which the mold clamping of the fixed mold 91 and the movable mold 92 is performed.

(D-4) In the embodiments described above, the injection molding apparatus 10 is a horizontal injection molding apparatus. In contrast, the injection molding apparatus 10 may be a vertical injection molding apparatus.

(D-5) The disclosure described above may be implemented in the form of a mold clamping device including the mold clamping unit 30 and the controller 40 instead of the injection molding apparatus 10.

### E. Other Aspects

The present disclosure is not limited to the embodiments described above, and can be implemented in various aspects without departing from the scope or the spirit of the present disclosure. For example, the present disclosure can also be implemented in the following aspects. In order to solve a part of or all of the problems of the present disclosure, or to achieve a part of or all of the advantages of the present disclosure, the technical features of the above embodiments corresponding to technical features in each of the following aspects can be replaced or combined as appropriate. In addition, the technical features can be deleted as appropriate unless described as essential features in the present specification.

(1) According to a first aspect of the present disclosure, an injection molding apparatus is provided. The injection molding apparatus is an injection molding apparatus configured to perform injection molding of a molded article using a molding die configured with a fixed mold and a movable mold, the apparatus s including an injection unit configured to inject a material of the molded article into the molding die, a mold clamping unit to which the molding die is attached and which is configured to perform mold clamping of the molding die, and a controller configured to control the injection unit and the mold clamping unit, wherein the mold clamping unit includes a toggle fixing plate, a fixed mold attachment portion to which the fixed mold is attached, a movable mold attachment portion which is disposed between the toggle fixing plate and the fixed mold attachment portion so as to be movable forward and backward in a mold clamping direction, and to which the movable mold is attached, a motor, a ball screw attached to the toggle fixing plate and configured to rotate due to driving of the motor, a crosshead configured to move between the toggle fixing plate and the movable mold attachment portion due to rotation of the ball screw, a toggle section coupled to the toggle fixing plate, the movable mold attachment portion, and the crosshead and configured to move the movable mold attachment portion along the mold clamping direction due to a movement of the crosshead, and a position detector configured to detect a position of the crosshead, and the controller drives the motor to control the position of the crosshead based on a detection result of the position detector to thereby make the toggle section operate to perform the mold clamping of the fixed mold and the movable mold.

According to such an aspect, the stop position of the crosshead at the time of mold clamping can be controlled more precisely than when the controller drives the motor to control the position of the crosshead based on the set value of the torque value. Therefore, it is possible to suppress the mold clamping force from varying when the mold clamping is repeatedly performed.

(2) In the aspect described above, the toggle section may include a first member coupled to the toggle fixing plate via a first rotary shaft, a second member coupled to the first member via a second rotary shaft and coupled to the movable mold attachment portion via a third rotary shaft, and a third member coupled to the crosshead and coupled to the first member via a fourth rotary shaft, and the controller may control the position of the crosshead such that a direction of a line connecting a center of the first rotary shaft and a center of the second rotary shaft and a direction of a line connecting the center of the second rotary shaft and a center of the third rotary shaft are along a same direction in a period in which the mold clamping of the fixed mold and the movable mold is performed.

According to such an aspect, it is possible to make it easy for the toggle section to stably receive the force applied to the toggle section when the material of the molded article is injected into the molding die.

(3) In the aspect described above, the controller may control the position of the crosshead so that the mold clamping of the fixed mold and the movable mold is performed with a first torque and then the mold clamping is performed with a second torque lower than the first torque in a period in which the mold clamping of the fixed mold and the movable mold is performed.

According to such an aspect, the life of the motor can further be extended.

(4) In the aspect described above, the controller may perform first control of driving the motor to control the position of the crosshead based on the detection result of the position detector to thereby make the toggle section operate to bring the fixed mold and the movable mold into contact with each other, second control of controlling a torque value of the motor so that the mold clamping of the fixed mold and the movable mold is performed with third torque and then the mold clamping is performed with fourth torque higher than the third torque after the first control, and third control of driving the motor to control the position of the crosshead based on the detection result of the position detector so that the mold clamping of the fixed mold and the movable mold is performed with fifth torque lower than the third torque after the second control.

According to such an aspect, even in the mold clamping operation requiring strong mold clamping force, it is possible to make it easy to move the crosshead to the position where the mold clamping of the fixed mold and the movable mold is performed.

(5) In the aspect described above, the mold clamping unit may include a fixing plate moving section configured to move the toggle fixing plate along the mold clamping direction, and the controller may control the fixing plate moving section to move the toggle fixing plate toward a direction in which mold clamping pressure increases during the period in which the mold clamping of the fixed mold and the movable mold is performed.

According to such an aspect, the mold clamping force of the mold clamping unit can further be increased.

(6) According to a second aspect of the present disclosure, a mold clamping device is provided. The mold clamping device includes a toggle fixing plate, a fixed mold attachment portion to which a fixed mold a position of which is fixed in a mold clamping operation is attached, a movable mold attachment portion which is disposed between the toggle fixing plate and the fixed mold attachment portion so as to be movable forward and backward in a mold clamping direction, and to which a movable mold which is moved relatively to the fixed mold in the mold clamping operation is attached, a motor, a ball screw attached to the toggle fixing plate and configured to rotate due to driving of the motor, a crosshead moving between the toggle fixing plate and the movable mold attachment portion due to rotation of the ball screw, a toggle section coupled to the toggle fixing plate, the movable mold attachment portion, and the crosshead and configured to move the movable mold attachment portion along the mold clamping direction due to a movement of the crosshead, a position detector configured to detect a position of the crosshead, and a controller configured to drive the motor to control the position of the crosshead based on a detection result of the position detector, to thereby make the toggle section operate to perform mold clamping of the fixed mold and the movable mold.

According to such an aspect, the stop position of the crosshead at the time of mold clamping can be controlled more precisely than when the controller drives the motor to control the position of the crosshead based on the set value of the torque value. Therefore, it is possible to suppress the mold clamping force from varying when the mold clamping is repeatedly performed.

What is claimed is:

1. An injection molding apparatus configured to perform injection molding of a molded article using a molding die configured with a fixed mold and a movable mold, the apparatus comprising:
an injection unit configured to inject a material of the molded article into the molding die;
a mold clamping unit to which the molding die is attached and which is configured to perform mold clamping of the molding die; and
a controller configured to control the injection unit and the mold clamping unit, wherein
the mold clamping unit includes
a toggle fixing plate,
a fixed mold attachment portion to which the fixed mold is attached,
a movable mold attachment portion which is disposed between the toggle fixing plate and the fixed mold attachment portion so as to be movable forward and backward in a mold clamping direction, and to which the movable mold is attached,
a motor,
a ball screw attached to the toggle fixing plate and configured to rotate due to driving of the motor,
a crosshead configured to move between the toggle fixing plate and the movable mold attachment portion due to rotation of the ball screw,
a toggle section coupled to the toggle fixing plate, the movable mold attachment portion, and the crosshead and configured to move the movable mold attachment portion along the mold clamping direction due to a movement of the crosshead, and
a position detector configured to detect a position of the crosshead, and
the controller drives the motor to control the position of the crosshead based on a detection result of the position detector to thereby make the toggle section operate to perform the mold clamping of the fixed mold and the movable mold.

2. The injection molding apparatus according to claim 1, wherein
the toggle section includes
a first member coupled to the toggle fixing plate via a first rotary shaft,
a second member coupled to the first member via a second rotary shaft and coupled to the movable mold attachment portion via a third rotary shaft, and
a third member coupled to the crosshead and coupled to the first member via a fourth rotary shaft, and
the controller controls the position of the crosshead such that a direction of a line connecting a center of the first rotary shaft and a center of the second rotary shaft and a direction of a line connecting the center of the second rotary shaft and a center of the third rotary shaft are along a same direction in a period in which the mold clamping of the fixed mold and the movable mold is performed.

3. The injection molding apparatus according to claim 1, wherein
the controller controls the position of the crosshead so that the mold clamping of the fixed mold and the movable mold is performed with a first torque and then the mold clamping is performed with a second torque lower than the first torque in a period in which the mold clamping of the fixed mold and the movable mold is performed.

4. The injection molding apparatus according to claim 1, wherein
the controller performs
first control of driving the motor to control the position of the crosshead based on the detection result of the position detector to thereby make the toggle section operate to bring the fixed mold and the movable mold into contact with each other,
second control of controlling a torque value of the motor so that the mold clamping of the fixed mold and the movable mold is performed with third torque and then the mold clamping is performed with fourth torque higher than the third torque after the first control, and
third control of driving the motor to control the position of the crosshead based on the detection result of the position detector so that the mold clamping of the fixed mold and the movable mold is performed with fifth torque lower than the third torque after the second control.

5. The injection molding apparatus according to claim 1, wherein
the mold clamping unit includes a fixing plate moving section configured to move the toggle fixing plate along the mold clamping direction, and
the controller controls the fixing plate moving section to move the toggle fixing plate toward a direction in which mold clamping pressure increases during the period in which the mold clamping of the fixed mold and the movable mold is performed.

6. A mold clamping device comprising:
a toggle fixing plate;
a fixed mold attachment portion to which a fixed mold a position of which is fixed in a mold clamping operation is attached;
a movable mold attachment portion which is disposed between the toggle fixing plate and the fixed mold attachment portion so as to be movable forward and backward in a mold clamping direction, and to which a movable mold which is moved relatively to the fixed mold in the mold clamping operation is attached;
a motor;
a ball screw attached to the toggle fixing plate and configured to rotate due to driving of the motor;
a crosshead moving between the toggle fixing plate and the movable mold attachment portion due to rotation of the ball screw;
a toggle section coupled to the toggle fixing plate, the movable mold attachment portion, and the crosshead and configured to move the movable mold attachment portion along the mold clamping direction due to a movement of the crosshead;
a position detector configured to detect a position of the crosshead; and
a controller configured to drive the motor to control the position of the crosshead based on a detection result of the position detector, to thereby make the toggle section operate to perform mold clamping of the fixed mold and the movable mold.
